(19) United States
(12) Patent Application Publication
(10) Pub. No.: US 2015/0332217 A1
(43) Pub. Date: Nov. 19, 2015

(54) METHOD FOR RETURNING ITEM

(71) Applicant: Momen Ahmad Sharab, Gwynn Oak, MD (US)

(72) Inventor: Momen Ahmad Sharab, Gwynn Oak, MD (US)

(21) Appl. No.: 14/280,771

(22) Filed: May 19, 2014

(51) Int. Cl. G06Q 10/08

(52) U.S. Cl. CPC G06Q 10/0837

(57) ABSTRACT

A method for returning an item includes a user obtaining an item from an item source. The item may then be used and converted into an at least partially used item. The user returns the unused portion of the item to the item source or a new user. The user receives a compensation for returning the partially used item. The item is returned in a return packaging having affixed thereto a return label and a return questionnaire to facilitate the return of the item through a return mechanism, such as a postal service. The partially used item can converted into a refurbished item for reuse. This reduces the cost of the item for the user by receiving the compensation, and also reduces waste of partially used items and reduce the cost and/or consumption of raw materials by manufacturer.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a method for returning items. More particularly, the invention relates to a method for returning at least partially used items and receiving compensation for the return.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that in retail, returning is the process of a customer taking previously purchased merchandise back to the retailer, and in turn, receiving a cash refund, exchange for another item, or a store credit.

Typically, retailers will accept returns if the customer has a receipt as a proof of purchase, and that certain other conditions, which depend on the retailer's policies, are met. The conditions may include the merchandise being in a certain condition, no more than a certain amount of time having passed since the purchase, or that identification be provided. In some cases, only exchanges or store credit are offered.

If the merchandise is partially used, the retailer often will not refund the customer. The customer often has difficulty returning the merchandise without the receipt, and even if allowed to return the merchandise, only store credit is offered. The partially used merchandise is often discarded due to the difficulty of returning the merchandise. Another way is to return used merchandise to a container already put in certain areas and this necessitate the customer to go and do efforts in order to return back used items while in my method, someone might need to put it in a mail box which is available everywhere with the used item already packed or has the return address on it so all needed is to put it in the mail box.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of an exemplary method for returning at least partially used items, where an exemplary user at least partially uses an exemplary item and returns the partially used item to receive a compensation, in accordance with an embodiment of the present invention;

FIG. 2 illustrates a flowchart diagram of an exemplary method for returning at least partially used items, in accordance with an embodiment of the present invention; and

FIGS. 3A and 3B illustrate top views of an exemplary return labeling, where FIG. 3A illustrates an exemplary return label, and FIG. 3B illustrates an exemplary return questionnaire, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of methods for returning items that may be provided by preferred embodiments of the present invention. In one embodiment of the present invention, the method for returning at least partially used items provides a systematic process for returning a portion of an item back to an item source or a new user, and receiving compensation for returning the at least partially used item. The compensation provides incentive to the user for returning at least partially used items. In this manner, cost for the item is reduced through the compensation, and the unused portion of the item is not wasted.

In some embodiments, the item may include any item that may be partially used, and still have functional or aesthetic value, especially for refurbishing and repackaging. The item may include, without limitation, a battery, a drug, a toy, paint, a food item, a technology item, a vehicle, and a beauty enhancement product. A user may initially receive the item form an item source, such as a vendor, a store, and a third party. The user may also receive a return packaging and an empty label for subsequent return of the item. The return packaging may include a clear, sealed bag. The label may include information pertinent to the partially used item, and the reason for the return.

In some embodiments, the user may return the partially used item through various means, including, without limitation, mail, personal return, and pick up by the item source or new user. The user may be compensated for the return, which in essence, reduces the cost of the item. The compensation may include, without limitation, a coupon, a monetary refund, a bonus item, and a charitable contribution. The incentive may be efficacious for encouraging the user to perform the additional steps necessary to return the partially used item. The item source may refurbish the partially used item a, or the new user may continue using the partially used item.

In some embodiments, the method may include an initial Step of obtaining, by a user, an item form an item source. A next Step may include at least partially using the item. A further Step comprises repackaging and affixing a label on the partially used item. In some embodiments, the method may include a Step of returning the partially used item to the item source or a new user. A next Step comprises compensating the user for returning the partially used item. A final Step comprises refurbishing or using the partially used item.

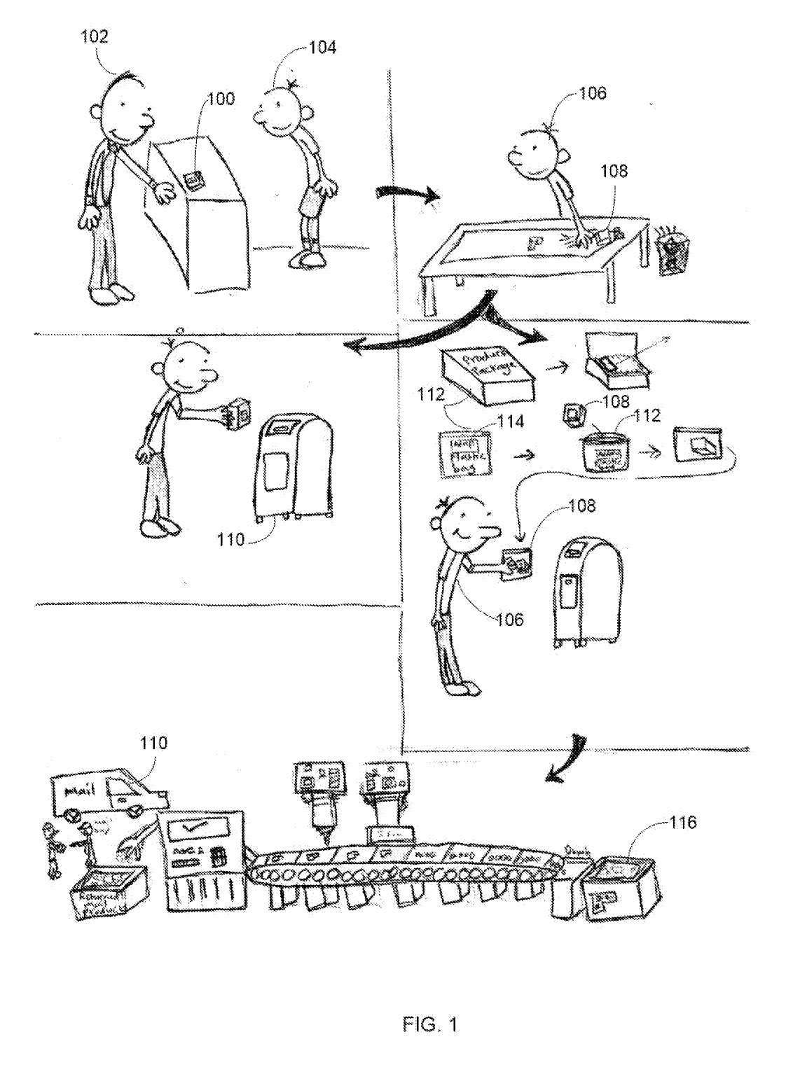

FIG. 1 illustrates a block diagram of an exemplary method for returning at least partially used items, where an exemplary user at least partially uses an exemplary item and returns the partially used item to receive compensation. The compensation provides incentive for the user to return the partially used item. In the present invention, a user 104 may obtain an item 100 from an item source 102. The item may then be used and converted into an at least partially used item 108. The user may return the unused portion of the item to the item source or a new user 106. The user may receive a compensation for returning the partially used item. The item may be returned in a return packaging 112 having affixed thereto a return label 114 and a return questionnaire to facilitate the return of the item through a return mechanism 110, such as a postal service. The partially used item may be converted into a refurbished item 116 for reuse.

In some embodiments, the method for returning at least partially used items provides a systematic process for returning a portion of an item back to an item source or a new user. The item source may include, without limitation, a vendor, a manufacturer, and an agent or another user who come to know about the item through a website or advertisement. The new user may include a different consumer in a geographically different location than the user or the item source.

In some embodiments, the item may be partially consumed or used, yet still have functional uses despite being used. In some embodiments, the item may include any item that may be partially used, and still have functional or aesthetic value. The item may include, without limitation, a battery, a drug, a toy, paint, a food item, a technology item, a vehicle, and a beauty enhancement product, clothing, a book, a tool a partially used gift card. After returning the partially used item, the user may receive compensation for returning the at least partially used item. The compensation provides incentive for returning at least partially used items. In this manner, cost for the item is reduced through the compensation, and the unused portion of the item is not wasted.

In some embodiments, the user may initially receive the item form an item source, such as a vendor, a store, and a third party. The user may also receive a return packaging and an empty label for subsequent return of the item. The return packaging may include a clear, sealed bag. The return packaging may include a return label containing shipping information, such as name, address, and zip code. The return packaging may also include a return questionnaire that helps clarify the item being returned and the reason for the return. In some embodiments, the return label and the return questionnaire are affixed to the item prior to use, when the user initially obtains the item. The item source affixes the return label, and the user may fill in the address information. The new user may be predetermined prior to the return. The item can me returned to the manufacturer personally, or email the manufacturer to have someone pick up the item.

In some embodiments, the user may return the partially used item through a return mechanism, which may include, without limitation, postal mail, personal return, and pick up by the item source or new user. The partially used item may be mailed to the item source to transform into a refurbished item. For example, a factory for recharging a battery and repackaging. However, the partially used item may also be sent to a new user to finish using the partially used item.

In some embodiments, the user may be compensated for the return, which in essence, reduces the cost of the item. The compensation may include, without limitation, a coupon, a monetary refund, a bonus item, or a charitable contribution. The incentive may be efficacious for encouraging the user to perform the additional steps necessary to return the partially used item. The item source may refurbish the partially used item, or the new user may continue using the partially used item. Alternatively, other motivations may be such as a green environmental supporter, who does a good thing in returning the item, like planting a tree.

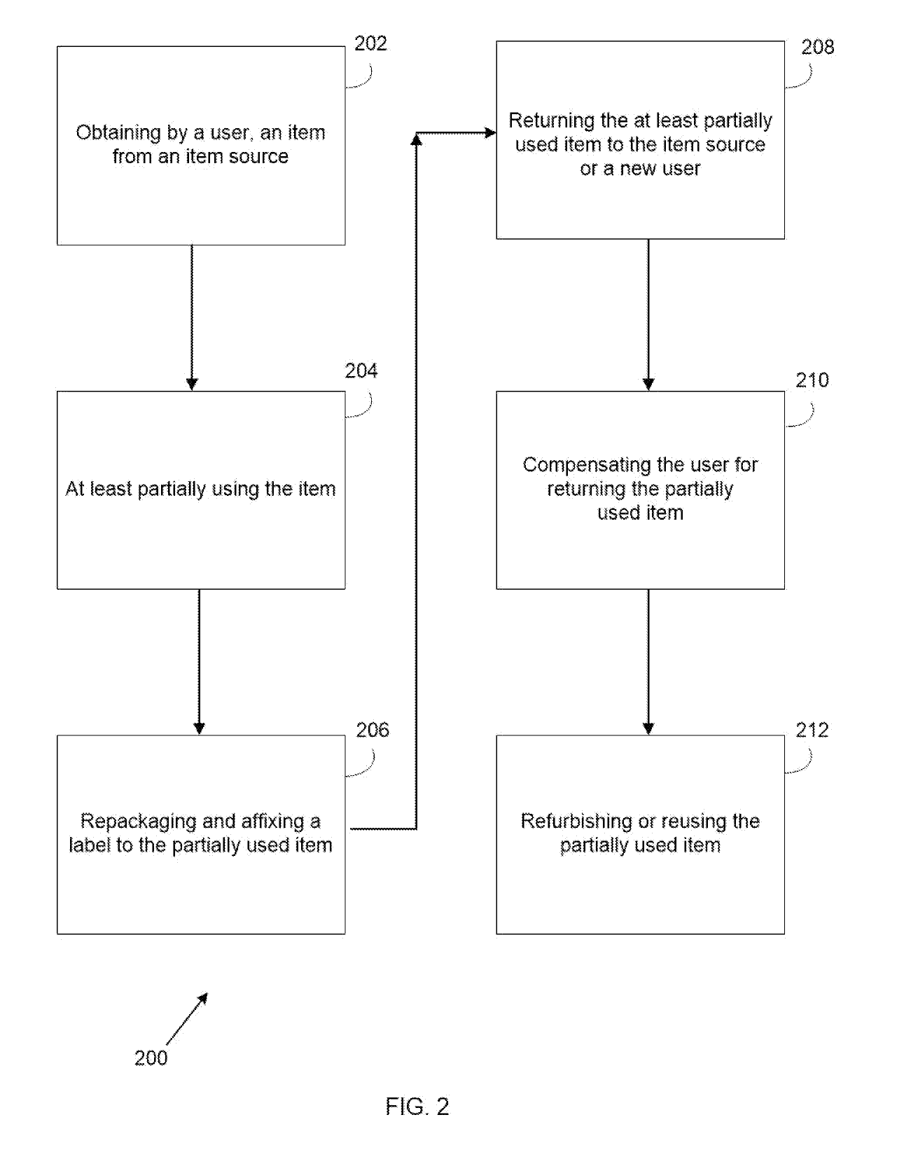

FIG. 2 illustrates a flowchart diagram of an exemplary method for returning at least partially used items, in accordance with an embodiment of the present invention. In the present invention, a method 200 may include an initial Step 202 of obtaining, by a user, an item form an item source. The item may include, without limitation, a battery, a drug, a toy, paint, a food item, a technology item, a vehicle, and a beauty enhancement product. A next Step 204 may include at least partially using the item. The item may be of a variety that can be at least partially used, such as a battery that is partially used, or a bottle of prescription drugs from which half the drugs are consumed. A further Step 206 comprises repackaging and affixing a label on the partially used item. In some embodiments, the return label and the return questionnaire are affixed to the item prior to use, when the user initially obtains the item.

In some embodiments, the method may include a Step 208 of returning the partially used item to the item source or a new user. The user may return the partially used item through a return mechanism, which may include, without limitation, postal mail, personal return, and pick up by the item source or new user. A next Step 210 comprises compensating the user for returning the partially used item. The compensation provides incentive to the user to perform the additional steps necessary to return the partially used item, such as repackaging the partially used item and taking the return packaging to the return mechanism. A final Step 212 comprises refurbishing or reusing the partially used item. The partially used item may be refurbished, repackaged, and resold for use as a new item.

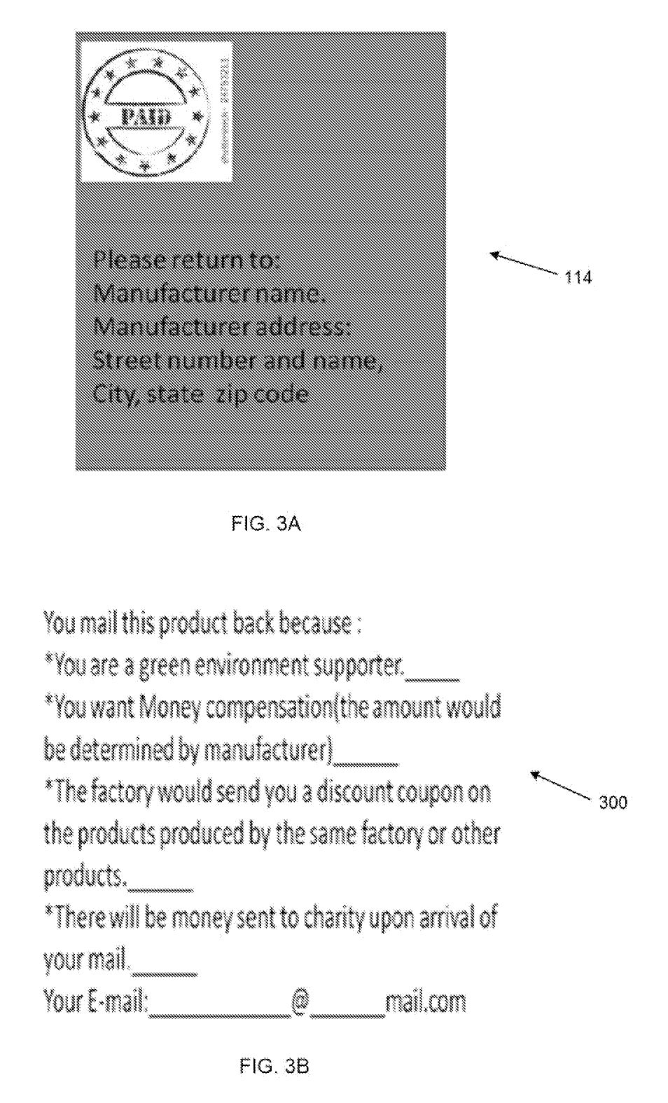

FIGS. 3A and 3B illustrate top views of an exemplary return labeling, where FIG. 3A illustrates an exemplary return label, and FIG. 3B illustrates an exemplary return questionnaire, in accordance with an embodiment of the present invention. In the present invention, the return packaging may include a clear, sealed bag. However in other embodiments, any container may be utilized to return the partially used item. For example, without limitation, a box, a sack, an envelope, and a cylinder. The return packaging may include a return label containing shipping information, such as name, address, and zip code. In one example, the return label may state:

Please return to: [Manufacturer Name]

### Manufacturer Address: [Street Number and Name, City, State Zip Code]

In some embodiments, the return packaging may also include a return questionnaire that helps clarify the item being returned and the reason for the return. The return questionnaire may state:

You mail this product because: ______.
You are a green environment supporter ______.
You want money compensation (amount determined by manufacturer) ______.
The factory would send you a discount coupon on the products produced by the same factory or other products ______.
There will be money sent to charity upon arrival of your mail. ______.
Your email: ______@______mail.com.
In some embodiments, the return label and the return questionnaire are affixed to the item prior to use, when the user initially obtains the item. The item source affixes the return label, and the user may fill in the address information. The new user may be predetermined prior to the return.

In one alternative embodiment, the item may be replaced by a service. In this embodiment, the service is only partially received, and the remainder of the service may be transferred to a new user, with the first user receiving partial compensation for the unused portion of the service. In another alternative embodiment, the user decides whether to return the partially used item to the item source or the new user after purchasing the item.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a method to return partially used items for compensation according to the present invention will be apparent to those skilled in the art. Various aspects of the invention have been described above by way of illustration, and the specific embodiments disclosed are not intended to limit the invention to the particular forms disclosed. The particular implementation of the method to return partially used items for compensation may vary depending upon the particular context or application. By way of example, and not limitation, the method to return partially used items for compensation described in the foregoing were principally directed to a method to return a partially used item with affixed return labels and predetermined compensation to the initial user of the partially used item implementations; however, similar techniques may instead be applied to corporations that want to reduce costs by reusing partially used items, especially to regular customers, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising:
obtaining, by a user, an item from an item source;
at least partially using said item;
repackaging and affixing a return label on an at least partially used item;
returning said at least partially used item;
providing a compensation for returning said at least partially used item; and
refurbishing or reusing said partially used item.

2. The method of claim 1, in which said user comprises a consumer.

3. The method of claim 2, in which said item source comprises a vendor.

4. The method of claim 3, in which said item comprises a battery.

5. The method of claim 4, in which said return label comprises an address, city, state, and zip code.

6. The method of claim 5, in which repackaging and affixing a return label on an at least partially used item further comprises affixing and filling out a return questionnaire.

7. The method of claim 6, in which said return questionnaire comprises questions pertinent to said compensation.

8. The method of claim 7, in which returning said at least partially used item comprises returning said at least partially used item in a return packaging.

9. The method of claim 8, in which said return packaging comprises a clear bag.

10. The method of claim 9, in which returning said at least partially used item comprises returning said at least partially used item through a return mechanism.

11. The method of claim 10, in which returning said at least partially used item further comprises tracking said at least partially used item.

12. The method of claim 11, in which said tracking comprises a postal tracking system.

13. The method of claim 12, in which said return mechanism comprises a postal mail.

14. The method of claim 13, in which said compensation comprises a coupon and/or a monetary amount.

15. The method of claim 14, in which refurbishing or reusing said partially used item further comprises recharging said battery.

16. The method of claim 15, in which refurbishing or reusing said partially used item further comprises repackaging said recharged battery.

17. The method of claim 16, in which refurbishing or reusing said partially used item further comprises a new user utilizing said recharged battery.

18. The method of claim 17, in which said new user comprises a second consumer.

19. A system comprising:
an item configured to be at least partially used by a user, said item provided by an item source;
a return label and a return questionnaire disposed to join a partially used item;
a return mechanism configured to return said partially used item to said item source or a new user according to said return label and said return questionnaire;
a tracking system configured to track said partially used item; and
a compensation configured to provide incentive to said user for returning said partially used item.

20. A method consisting of:
obtaining, by a user, an item from an item source, said user comprising a consumer, said item comprising a battery, said item source comprising a vendor;
at least partially using said item, said partial usage comprising using said battery;
repackaging and affixing a return label on an at least partially used item, said return label comprising an address, said at least partially used item further comprising a return questionnaire, said return questionnaire comprising questions pertinent to said at least partially used item;
returning said at least partially used item, returning said at least partially used item comprising returning said at least partially used item in a return packaging, said return packaging comprising a clear bag;
providing a compensation for returning said at least partially used item, said compensation comprising a coupon and/or a monetary amount; and
refurbishing or reusing said partially used item, refurbishing or reusing said partially used item further comprises recharging said battery.
